(19) United States
(12) Patent Application Publication
(10) Pub. No.: US 2026/0261501 A1
(43) Pub. Date: Sep. 3, 2026

(54) TRANSFORMING LINK METRICS INTO SDWAN OVERLAY LEVEL INTELLIGENCE FOR PATH SELECTION

(71) Applicant: Palo Alto Networks, Inc., Santa Clara, CA (US)

(72) Inventors: Naga Raghu Ramprasad Nandigama, Bangalore (IN); Harsha Kumar Subramanya Gupta, Mysore (IN); Arunkumar Mutharasanallur Desigan, Seegehalli (IN)

(21) Appl. No.: 19/067,504

(22) Filed: Feb. 28, 2025

(51) Int. Cl. H04L 45/12

(52) U.S. Cl. CPC H04L 45/123

(57) ABSTRACT

A path performance quantifier that operates on an SD-WAN controller has been created to generate composite performance weights (“path weights”) that can be used to inform path selection decisions by nodes (i.e., overlay devices) in an overlay network. With telemetry data for link metrics of the overlay, the path performance quantifier computes moving averages for metrics of each link in the overlay. The path performance quantifier then uses the moving averages to compute composite performance weights for paths in the overlay. To compute a composite performance weight for a path, the path performance quantifier aggregates the moving averages of the links that form the path. As a pairing of nodes can have multiple paths therebetween, the path performance quantifier ranks the paths of a node pairing. The SD-WAN controller then distributes the path rankings.

### BACKGROUND

The disclosure generally relates to selection of paths in a Software-Defined Wide Area Network (SD-WAN) (e.g., CPC subclass G06F)

The terms wide area network (WAN) and local area network (LAN) identify communications networks of different geographic scopes. For a LAN, the geographic area can range from a residence or office to a university campus. For a WAN, the geographic area can be defined with respect to a LAN-greater than the area of a LAN. The software-defined networking (SDN) paradigm decouples a network management control plane from the data plane. A SDN controller that implements the control plane imposes rules on switches and routers (physical or virtual) that handle Internet Protocol (IP) packet forwarding in the data plane.

An SD-WAN is a WAN managed with SDN technologies. Enterprise networks can include one or more private networks across multiple branch offices and one or more data centers that form an SD-WAN. An SD-WAN controller is used to manage the SD-WAN. As an application of the SDN paradigm, the SD-WAN controller operates as a control plane for the data planes of nodes in the SD-WAN for routing decisions for traffic flows. SD-WAN management of the overlay is decoupled from the underlay, which is the underlying transport components.

### BRIEF DESCRIPTION OF THE DRAWINGS

Embodiments of the disclosure may be better understood by referencing the accompanying drawings.

FIG. 1 is an illustrative diagram of a path performance quantifier ranking paths for source-destination node pairs in an overlay network based on a composite performance weight computed for each path.

FIG. 2 is a flowchart of example operations for ranking SD-WAN paths based on composite performance weights computed for each path.

FIG. 3 is a flowchart of example operations for calculating the path weight of an SD-WAN path based on moving averages of observed link metrics corresponding to the path.

FIG. 4 is a flowchart of example operations for generating path rankings using time-series predictions of moving averages.

FIG. 5 is a flowchart of example operations for computing path weights based on predictions of moving averages for time metrics.

FIG. 6 is a flowchart of example operations for computing path weights based on predictions of path weights.

FIG. 7 depicts an example computer system with a path performance quantifier.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

The description refers to a “link” and a “path”. A “link” in this disclosure refers to a link in an SD-WAN overlay network, such as a tunnel between nodes in the overlay network. A “path” is one or more links in an overlay network that form a path between a source node and a destination node.

The Specification uses the terms metric and metric data or metric values. For the sake of brevity, the description will sometimes simply refer to a metric instead of a metric value or metric data as done colloquially.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Introduction

Path selection in a conventional SD-WAN is commonly based on traffic routing policies optimized for device level decision making. This can lead to un-optimized path selections since network devices lack awareness of path conditions beyond the next destination device in the path (e.g., network latency, bandwidth, hop count to destination). Furthermore, path selection may react to transitory or temporary conditions in the network (e.g., latency spikes) and make a sub-optimal path selection.

### Overview

A path performance quantifier that operates on an SD-WAN controller has been created to generate composite performance weights (“path weights”) that can be used to inform path selection decisions by nodes (i.e., overlay devices) in an overlay network. With telemetry data for link metrics of the overlay, the path performance quantifier computes moving averages for metrics of each link in the overlay. The path performance quantifier then uses the moving averages to compute composite performance weights for paths in the overlay. Use of the moving averages preserves the awareness of temporary conditions affecting a link metric without allowing it undue influence on path selection. To compute a composite performance weight for a path, the path performance quantifier aggregates the moving averages of the links that form the path. This provides a path level performance beyond the limited visibility of individual link performance. As a pairing of nodes can have multiple paths therebetween, the path performance quantifier ranks the paths of a node pairing. The SD-WAN controller then distributes the path rankings to allow the nodes to make decisions based on path level intelligence.

### Example Illustrations

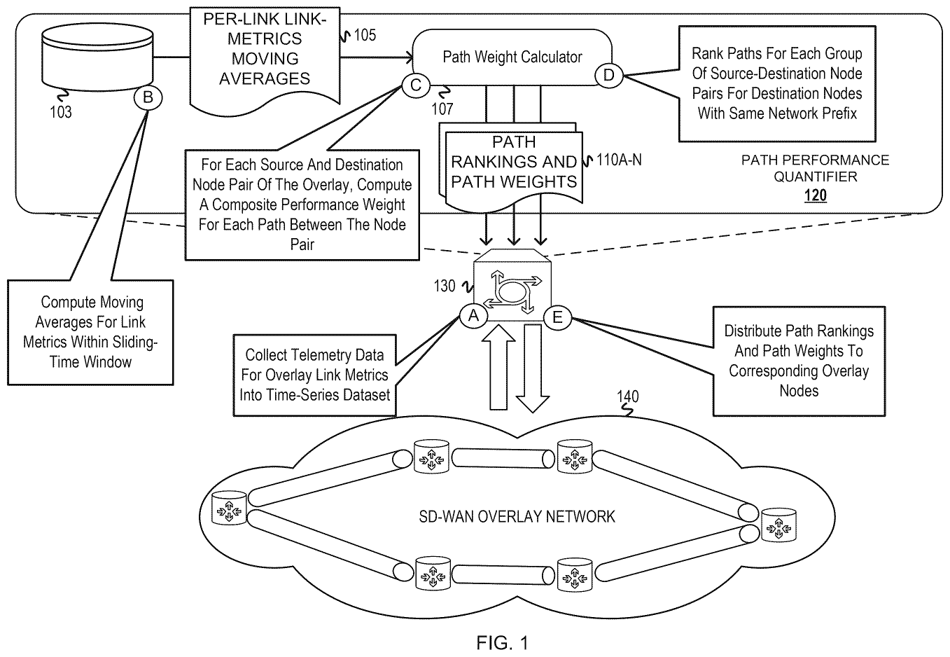

FIG. 1 is an illustrative diagram of a path performance quantifier ranking paths for source-destination node pairs in an overlay network based on a composite performance weight computed for each path. FIG. 1 depicts an SD-WAN overlay network 140 (henceforth “overlay”). An SD-WAN controller (“controller”) 130 collects telemetry data for link metrics from nodes in the overlay 140 and communicates the telemetry data to a path performance quantifier 120. FIG. 1 depicts the path performance quantifier 120 as part of the controller 130, but it can be a separate component in some implementations. The path performance quantifier 120 includes a path weight calculator 107 that computes composite performance path weights based on moving averages 105 for the link metrics in the collected telemetry data for each link in the overlay 140. The path performance quantifier 120 ranks paths based on the composite performance path weights (“path weights”), which are used to inform path selection by the overlay nodes.

FIG. 1 is annotated with a series of letters A-E representing stages of operations, each stage corresponding to one or more operations. Although these stages are ordered for this example, the stages illustrate one example to aid in understanding this disclosure and should not be used to limit the claims. Subject matter falling within the scope of the claims can vary from what is illustrated.

At stage A, the SD-WAN controller (“controller”) 130 collects telemetry data for overlay link metrics. Example link metrics the controller collects include bandwidth and latency. The controller 130 (or another collection point associated with the controller 130) collects the telemetry data and stores it as time-series data. In this illustration, the telemetry data is added to a repository 103 for hosting a time-series dataset. The repository or time-series dataset 103 may have different sub-datasets or tables for each type of collected metric (e.g., bandwidth, latency) and will store the collected link metrics based on their metric type.

At stage B, the path performance quantifier 120 computes the moving averages 105 for link metrics within a sliding time window. The sliding time window is defined to encompass a quantity of metric values observed as being informative without being unduly influenced by outliers (e.g., 10-minute time window). Step rate of the sliding time window is also defined to capture sufficient informative information (e.g., advancing the 10-minute time window by 2 minutes at each step). For each link and corresponding set of link metrics, the path performance quantifier 120 retrieves time-series values of the set of link metrics from the time-series dataset 103 in the sliding time window. With the retrieved time-series values, the path performance quantifier 120 computes the moving average for each link metric for each link in the overlay 140 to generate per-link link metrics moving averages 105. Over time, the path performance quantifier 120 recurrently computes moving averages corresponding to the sliding time window.

At stage C, the path weight calculator 107 computes a composite performance path weight (“path weight”) for each path between each source and destination node pair of the overlay based on corresponding ones of the per-link link metrics moving averages 105 to generate path rankings and path weights 110A-110N. The path weight calculator 107 iterates over each pairing of source and destination nodes in the overlay 140. For each path between a source and destination node pair, the path performance quantifier 120 uses those of the per-link link metrics moving averages 105 that correspond to the links that form the path. The path weight calculator 107 aggregates the moving averages of the link metrics for the links to create moving averages for the path for each metric. The path weight calculator 107 then combines/aggregates the path moving averages to generate a path weight for the path.

To provide an illustrative example, imagine a path with two links (A-B) and (B-C), where A is a source node and C is a destination node. The link (A-B) has a moving average for latency of 300 milliseconds (ms). The link (B-C) has a moving average for latency of 100 ms. Therefore, the moving average latency for the entire path is 400 ms. Some metrics are proportional to path performance (e.g., bandwidth). Other metrics are inversely proportional to path performance (e.g., latency). The path performance quantifier 120 computes the path weight for a path by aggregating the values for each type of metric. For example, if a path is evaluated using metrics for bandwidth and latency, then a path weight can be generated by dividing the moving average of the bandwidth by the moving average of the latency (e.g., 200 ms/100 megabytes (Mb)/s=path weight of 2). The resulting composite performance weight is a measurement of the quality of the path for the time window.

At stage D, the path performance quantifier 120 ranks paths corresponding to groups of source-destination node pairs for destination nodes with the same network prefix. As multiple paths likely occur between a source-destination node pair, the path performance quantifier 120 ranks the multiple paths based on the computed path weights. Since a local network, such as a branch office, will likely have multiple nodes as gateways to the local network, ranking can also be by source and destination prefix pairs. Ranking by prefix allows for less granular grouping of paths which accounts for the individual destination nodes corresponding to the same destination from the perspective of a source node.

At stage E, the controller 130 distributes the path rankings and path weights 110A-110N to the corresponding overlay nodes. The controller 130 provides the path rankings and path weights 110A-110N to the corresponding nodes based on the path's source node prefix. For example, if a path has the source node prefix “192.168.0.0/24”, the controller 130 distributes the corresponding path ranking and path weights to overlay nodes that share the same prefix. In some implementations, the paths may be grouped by destination prefix or both source and destination prefix pairings to yield a summarized version of path rankings. The controller 130 may distribute a summarized version of the path rankings and path weights to the corresponding overlay nodes to maintain a smaller memory footprint. Furthermore, the controller 130 may distribute ranked paths at different granularities to nodes of a branch office compared to nodes of a data center based on the greater compute and memory resources of data center nodes, for example.

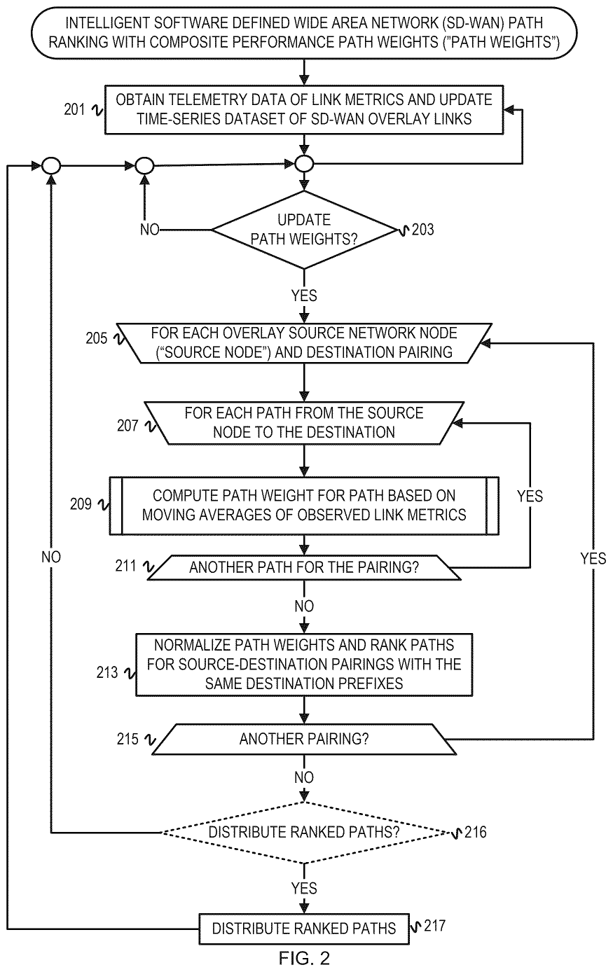

FIGS. 2-6 are flowcharts of example operations related to intelligent software defined wide area network (SD-WAN) path ranking based on composite performance weights. The example operations are described with reference to a SD-WAN controller for consistency with FIG. 1 and/or ease of understanding. The example operations refer to the SD-WAN controller since the functionality for computing path weights and ranking paths will most likely be performed by the SD-WAN controller or a process in communication with the SD-WAN controller. The program code for a SD-WAN controller can be modified to implement the functionality or be modified to invoke functions defined in libraries that include the logic or programming for computing path weights and ranking paths.

FIG. 2 is a flowchart of example operations for ranking SD-WAN paths based on composite performance weights computed for each path. The operations are depicted as ongoing in accordance with control plane functionality being ongoing in pursuit of optimized network performance.

At block 201, the SD-WAN controller obtains telemetry data of link metrics and updates a time-series dataset of SD-WAN overlay links. The link metrics are a set of metrics (e.g., bandwidth, latency, hop count) that are useful for determining the performance of different paths in the SD-WAN. The SD-WAN controller collects the link metric values continuously from the overlay nodes and stores them in a time-series dataset. Collection of the telemetry data is ongoing, for example every 30 milliseconds, as depicted with operational flow returning to block and proceeding to block 203.

At block 203, the SD-WAN controller determines whether to update the path weights for paths in the overlay. The SD-WAN controller can be configured to update path weights periodically based on the step of the sliding time window (e.g., every 5 minutes). This could be aligned or staggered from the moving average window. Updates to path weights may be event driven instead of or in addition to temporally driven. A manual request can be made or event detected, such as loss of a link or node or an alarm indicating a problem of a link or node. If the SD-WAN controller has determined to update the path weights, operational flow continues at block 205. Otherwise, operational flow returns to block 203. Implementations can insert a delay or time period into this execution path. The initial distribution of path rankings can be upon path ranking and then the configured event or time-based computation of path weights commences.

At block 205, the SD-WAN controller begins to iterate over each overlay source node (“source node”) and destination pairing. A pairing can be a source node and destination prefix or source node and destination node. In some implementations, a pairing is between source prefix and destination prefix, but the example operations presume pairings at source node granularity.

At block 207, the SD-WAN controller begins to iterate over each path from the source node to the destination node. Although a source node-destination pair may have a single path between them, there will likely be multiple paths in the overlay between the source node and destination.

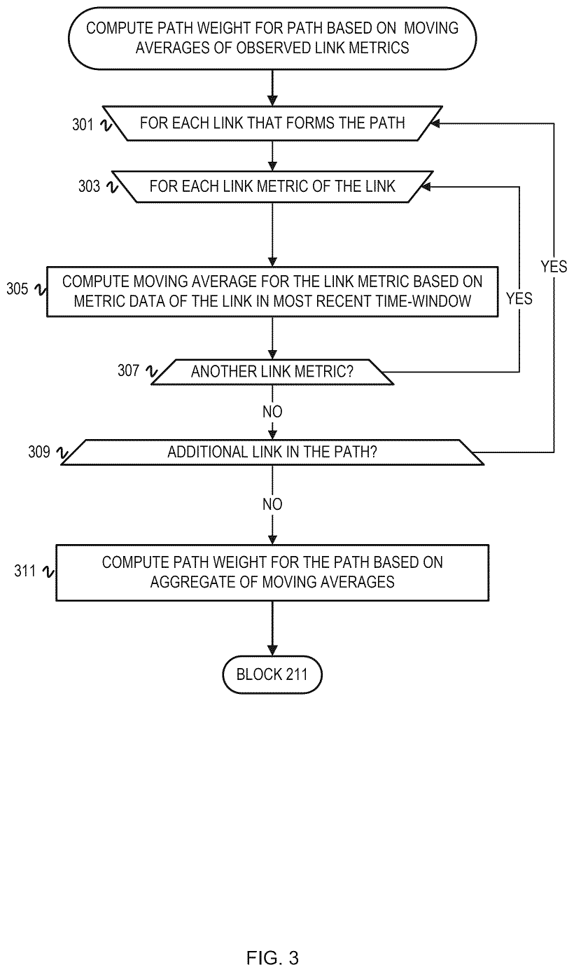

At block 209, the SD-WAN controller computes the path weight for the path based on the corresponding moving averages of observed link metrics. FIG. 3 further describes the operations for computing the path weights.

At block 211, the SD-WAN controller determines if there is another path for the pairing of source node and destination. If there is another path, then operational flow returns to block 207. Otherwise, operational flow continues at block 213.

At block 213, the SD-WAN controller normalizes the path weights and ranks the paths for each source node and destination pairing. While normalization is not necessary, normalizing of the path weights before ranking can yield more coherent path weights constrained to a range of [0, 1], for example. To illustrate, a first path weight without normalization may be 500 Mb/s/ 15 ms=33.333, a second path weight may be 350 Mb/s/ 25 ms=14, and a third path weight may be 700 Mb/s/ 20 ms=35. While 35, 33.333, and 14 sufficiently convey relationships of the weights in terms of absolute values, the variation in values could be overwhelming when visualized or otherwise reported and fail to coherently present relative performance of the paths. If normalized with respect to the greatest raw path weight, the path weights become 1, 0.95, and 0.4. The SD-WAN controller stores the path rankings and their corresponding weights in a data structure. The SD-WAN controller can be configured to store the raw weights and normalized weights or only store the normalized weights to reduce the memory footprint of the path weights. The normalizing and ranking in this example illustration is by source node and destination prefix even if the path weights were computed for each source node and destination node to reduce the footprint by aggregating or summarizing by destination prefix. However, implementations can normalize and rank at destination node granularity.

At block 215, the SD-WAN controller determines if there is another source and destination pairing. If there is another pairing, operational flow returns to block 205. Otherwise, operational flow continues at block 216.

At block 216, the SD-WAN controller determines whether to distribute the ranked paths to the corresponding overlay nodes. The SD-WAN controller can be programmed or configured to distribute the ranked paths to the nodes based on a defined criterion or criteria. Examples of criteria for distributing path rankings include an extent of change in path weights exceeding a threshold (e.g., 10% change from the previous path weight), change in a parameter of the sliding time window, an upcoming maintenance event, and expiration of a time to live defined for path rankings. Furthermore, a distribution criterion can be evaluated for the aggregate of path rankings or to individual source-destination pairings. This block is dashed to represent it is optional based on whether there are criteria configured by the SD-WAN controller for distributing the ranked paths. The SD-WAN controller is not necessarily programmed or configured to make a decision and may proceed to distribution after ranking. If the SD-WAN controller determines that the path rankings are to be distributed, then operational flow proceeds to block 217. If the SD-WAN controller determines that the path rankings are not to be distributed, then operational flow returns to block 203.

At block 217, the SD-WAN controller distributes the ranked paths. The SD-WAN controller can distribute path rankings based on prefixes or network addresses of the source nodes corresponding to the source-destination pairings.

An example data structure is depicted below in Table 1 which stores path rankings and weights for paths between a source and possible destinations in the overlay. Destination Prefix SD-WAN Paths Path Weights

TABLE 1
Ranked SD-WAN Paths for overlay nodes
sharing source prefix: SPFx1

| Destination Prefix | SD-WAN Paths | Path Weights |
|---|---|---|
| DPfx1 | wp1 | w1 |
| | wp2 | w2 |
| | wp3 | w3 |
| DPfx2 | wp4 | w4 |
| | wp5 | w5 |
| DPfx3 | wp6 | w6 |
| | wp7 | w7 |

The source in this example is identified by source prefix “SPF×1”. The data structure represented by Table 1 would be distributed to each node in the overlay with the prefix “SPF×1”. Table 1 shows three destination prefixes: “DPf×1”, “DPf×2” and “DPf×3”. Each destination prefix has an associated set of paths. For example, the destination prefix “DPf×1” has the associated SD-WAN paths “wp1”, “wp2”, and “wp3”. Each path has an assigned path weight. After distributing all the ranked paths and weights to their corresponding nodes, operational flow returns to block 203.

FIG. 3 is a flowchart of example operations for calculating the path weight of an SD-WAN path based on moving averages of observed link metrics corresponding to the path. These example operations depict calculation of the moving averages as part of computing the path weight. However, implementations may compute the moving averages as telemetry data is collected. These implementations could retrieve the moving averages instead of calculating the moving averages.

At block 301, the SD-WAN controller iterates through each link that forms the path. A data structure maintained in the control plane can associate a path identifier and constituent links.

At block 303, the SD-WAN controller iterates through each link metric of the link. The collected telemetry data may be accessed by link identifier and metric label.

At block 305, the SD-WAN controller calculates/computes the moving average for the link metric based on metric data of the link in the most recent time-window. The SD-WAN controller retrieves metric data from the repository of time-series metrics data that corresponds to the currently selected link.

At block 307, the SD-WAN controller determines if there is another link metric to process. If there is another link metric to process, operational flow returns to block 303. Otherwise, operational flow continues at block 309.

At block 309, the SD-WAN controller determines if there is another link that forms the path that hasn't been processed yet. If there is another link to process, then operational flow returns to block 301. Otherwise, operational flow continues at block 311.

At block 311, the SD-WAN controller computes a path weight for the path based on an aggregate of moving averages. Aggregation can be done in 2 parts: 1) aggregating the moving averages for each metric to obtain path level moving averages for each metric, and then 2) aggregating the path level moving averages into a path weight. Aggregation of the path level moving averages of the different metrics can vary based on how the weights are to be interpreted as indicating performance (e.g., larger weights represent better performance) and the relationship (inversely or directly proportionate) of the metrics to performance. While factors and coefficients could be employed, a straightforward paradigm for performance weight calculation could multiply the metric values. However, those metric values having an inversely proportionate relationship with the performance paradigm chosen for path weight performance would be inverted before aggregation. Continuing with the previously assumed path performance weight paradigm, bandwidth has a directly proportionate relationship with path performance and latency has an inversely proportionate relationship with path performance. Aggregating a bandwidth B and latency L to generate a path weight can be computed by the formula (B/L).

Aggregation can also involve normalization of the moving averages prior to computing path weights. The SD-WAN controller may normalize the moving averages of the links that form a path with respect to the greatest moving average of the corresponding metric. Normalization ranges can vary by design/preference. Embodiments may normalize moving averages before aggregating the normalized moving averages and again normalize the path weights that were previously described with reference to block 213. Operational flow continues from block 311 to block 211.

Implementations do not necessarily iterate through all metrics of a link before proceeding to aggregate across metrics to compute the path weight. An implementation can aggregate across metrics of a link based on the proportional relationships with path performance to generate a composite performance link weight. After computing the composite performance link weights for links of a path, these composite performance link weights can be aggregated into a path weight.

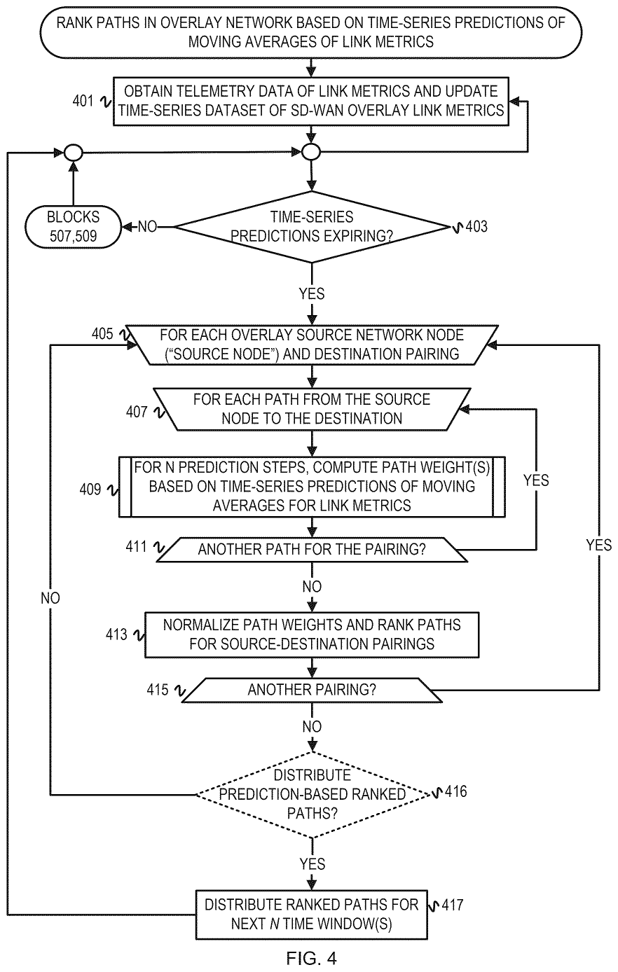

Embodiments are not limited to current intelligence and can use predictive techniques to effectively “cache” path rankings to be applied in the future. These embodiments can predict telemetry data, predict moving averages, and/or predict path weights. FIGS. 4-6 are flowcharts of example operations that correspond to incorporating predictive techniques for intelligent path weight computation.

FIG. 4 is a flowchart of example operations for generating path rankings using time-series predictions of moving averages. Paths are ranked by on path weights computed based on predictions of moving averages of metrics generated by a time-series model (also can be referred to as a “forecasting” model). The operations of FIG. 4 have similar blocks of operations to some described in reference to FIG. 2. For the sake of brevity, the description will only briefly describe repeated operations.

At block 401, the SD-WAN controller obtains telemetry data of link metrics and updates a time-series dataset of SD-WAN overlay link metrics.

At block 403, the SD-WAN controller determines if the path weights based on time-series predictions provided to the nodes are expiring. In the case that no prediction-based path weights have yet been distributed, the SD-WAN controller can be configured to treat that case as expired prediction-based path weights. If prediction-based path weights have been distributed previously, then expiration can be based on an event and/or temporal condition. Examples of events that indicate or correlate to expiration of prediction-based path weights include alerts related to a path or node, a request, and detection of a topological change in the overlay. An example of a temporal condition can be a temporal condition based on the prediction horizon. For example, the SD-WAN controller can generate predictions at 1 hour steps up to a 5-hour horizon. The path weights based on the 5^{th} hour predictions presumably are applied at the 5^{th} hour and expired at the 6^{th} hour. Thus, the SD-WAN controller would determine at the 5^{th} hour that prediction-based path weights are expiring. Of course, implementations can configure expiration differently, such as at time T-2 where T is the prediction horizon. If the SD-WAN controller is configured to perform single step predictions, then this operation will not be performed, and operations will proceed to block 405. If the time-series predictions are expiring, then operational flow continues at block 405. If the time-series predictions are not expiring, operational flow continues at block 507. Operations corresponding to blocks 507 and then block 509 would be performed before operational flow returns to block 403.

Blocks 405 and 407 are substantively the same as block 205 and 207 respectively. The SD-WAN controller iterates through each source and destination pairing in the overlay and through each path of the pairings. Operational flow continues from block 407 to block 409.

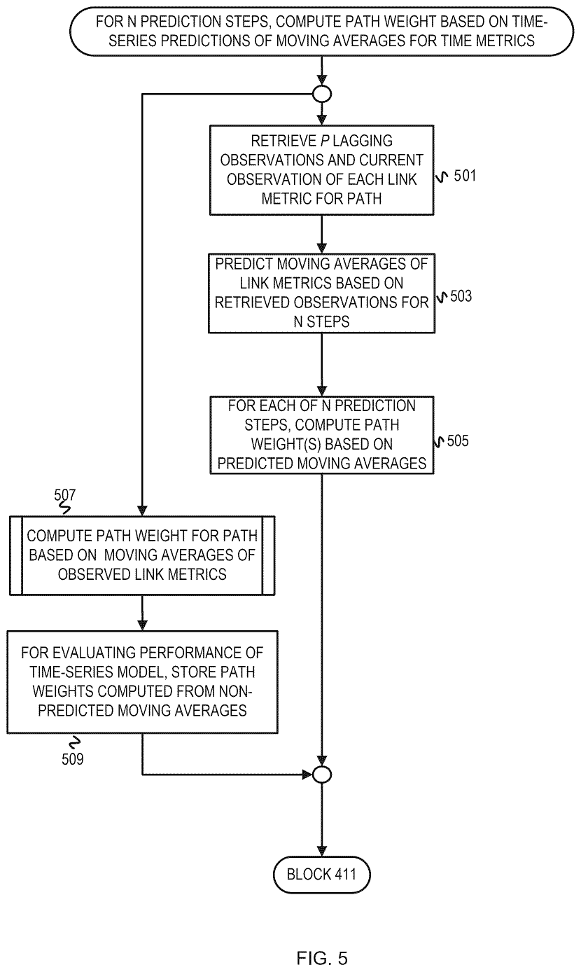

At block 409, the SD-WAN controller computes a path weight(s) based on the time-series predictions of moving averages for link metrics. FIG. 5 further describes example operations for computing path weight(s) based on time-series predictions of moving averages for link metrics.

Blocks 411, 413 and 415 and substantively the same as block 211, 213, and 215 respectively. The SD-WAN controller completes iterating through the paths for a source-destination pairing and then normalizes the computed path weights for the pairing and ranks the paths according to the normalizing weights. After ranking, the SD-WAN controller would continue to the next source-destination pairing to process. If there is no additional pairing to process, then operational flow proceeds to block 416.

At block 416, the SD-WAN controller determines whether to distribute the prediction-based path weights to their corresponding overlay nodes. In addition to the previously described criteria for distributing the ranked paths, the determination that time-series predictions are expiring as described in block 403 can be sufficient to trigger the distribution of the ranked paths. This block of operation is dashed to represent it as an optional operation based on whether the SD-WAN controller is configured to distribute the ranked paths based on a trigger. In some cases, after acquiring the new ranked paths, the SD-WAN controller will automatically distribute them. If the SD-WAN controller determines to distribute the prediction-based path weights, then operational flow continues at block 417. Otherwise, operational flow returns to block 405.

At block 417, the SD-WAN controller distributes the prediction-based ranked paths for the next N time windows. The SD-WAN controller will distribute the ranked paths and path weights for each the next N prediction steps. Since the distributed path rankings are to be applied in the future, they are distributed with expirations (e.g., time to live values) and/or a future timestamp when the corresponding set of ranked paths should be used. In the case of distributing with a time to live (TTL) value and no future timestamp, the control plane can distribute the sets of ranked paths with a defined ordering and the data plane (i.e., overlay nodes) can adhere to the ordering as expirations occur.

The example operations of FIG. 4 are directed to predicting the moving averages, but embodiments are not so limited. Instead, path weights can be based on moving averages computed from predicted telemetry data. For instance, time-series predictions of metrics can be generated to use if observed metrics are lost or corrupted, to normalize time-series when data across links at the same time resolution is not available, etc. The predicted time-series metric values can be used to fill in gaps in time-series data, whether the gap is a minute or a day.

FIG. 5 is a flowchart of example operations for computing path weights based on time-series predictions of moving averages for time metrics. The operations of FIG. 5 presume the SD-WAN controller has been continuously or periodically collecting link metrics into a time-series dataset as previously described. FIG. 5 depicts two paths of execution that can occur in parallel. One path of execution begins at block 501 and the other path of execution begins at block 507.

At block 501, the SD-WAN controller retrieves P lagging observations and a current observation of each link metric for a path. P represents the number of historical observations in a time-series that lag behind a current observation.

At block 503, the SD-WAN controller predicts moving averages of link metrics based on the retrieved observations for N steps. The moving averages can be predicted based on the retrieved observations or based on moving averages computed from the retrieved observations depending upon how the time-series model was trained. The SD-WAN controller provides the retrieved observations for each link metric of each link or moving averages computed therefrom as inputs to the time-series model (e.g., an autoregressive integrated moving average (ARIMA) or seasonal ARIMA (SARIMA) model).

At block 505, the SD-WAN controller computes, for each of the N prediction steps, a path weight(s) based on the predicted moving averages. This operation is substantively similar to the operation described in block 311 but uses the predicted moving averages. Operational flow continues from block 505 to block 411.

At block 507, the SD-WAN controller computes the path weight for the path based on moving averages of observed link metrics. FIG. 3 describes operations in more detail for block 507.

At block 509, the SD-WAN controller stores the path weights computed from non-predicted moving averages to evaluate performance of the time-series model. The path weights are stored in a list or dataset that can be retrieved by an administrator of the SD-WAN to compare the path weights computed from the non-predicted moving averages to the path weights computed based on the predicted moving averages. Performance of the time-series model can be evaluated based on the observed and predicted values.

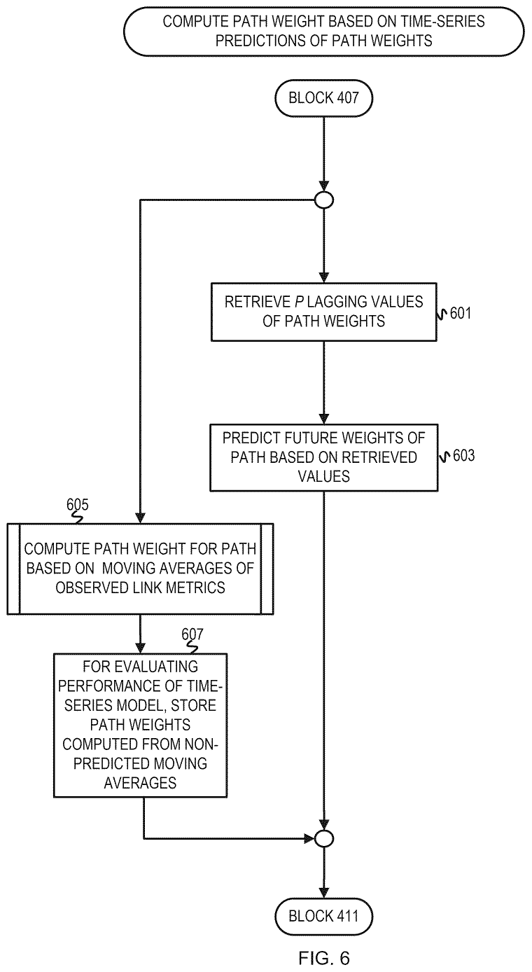

FIG. 6 is a flowchart of example operations for computing path weights based on time-series predictions of path weights. The operations of FIG. 6 are similar to those depicted in FIG. 5 but predict path weights instead of moving averages. The operations of FIG. 6 presume all the operations described in blocks 401-407 have been performed. In this embodiment, the operations described in FIG. 6 replace the operations of block 409. Similarly to FIG. 5, FIG. 6 depicts two paths of execution that can occur in parallel. One path of execution begins at block 601 and the other path of execution begins at block 605.

At block 601, the SD-WAN controller retrieves P lagging values of path weights. The SD-WAN controller retrieves the P most recent path weights that have been computed based on non-predicted moving averages of observed link metrics during each time window.

At block 603, the SD-WAN controller predicts future weights of the path based on the retrieved values. Similar to the operations of block 503, the SD-WAN controller provides the retrieved values as inputs to the time-series model and receives the predicted path weights. The time-series model will predict the path weights for a configured number of time windows in the future. Operational flow continues to block 411 from block 603.

Blocks 605 and 607 are similar to blocks 507 and 509, respectively. The operations of blocks 605 and 607 are performed asynchronously with the operations of block 601 and 603. Operational flow continues to block 411.

### Variations

The flowcharts of FIGS. 4-6 describe an embodiment that uses a time-series forecast such as an ARIMA model to perform its forecasting. Because an ARIMA model expects stationary values as well as common input and output types, the above embodiment performs operations in a way that is compatible with the constraints of an ARIMA model. In some cases, time-series models that do not expect stationary values or common input and output types can be used to predict moving averages of link metrics and path weights. For example, the use of a long short-term memory (LSTM) or a gated recurrent unit (GRU)-based model can be used. These are examples of recurrent neural networks (RNNs) which can receive non-stationary raw observation values such as the collected metric values for the overlay links and output moving averages for a sliding time window. This can be performed because these models can be trained to learn dependency between raw observed values and future moving averages.

The flowcharts are provided to aid in understanding the illustrations and are not to be used to limit the scope of the claims. The flowcharts depict example operations that can vary within the scope of the claims. Additional operations may be performed; fewer operations may be performed; the operations may be performed in parallel; and the operations may be performed in a different order. With respect to FIG. 2, normalizing path weights is not necessary. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, which employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

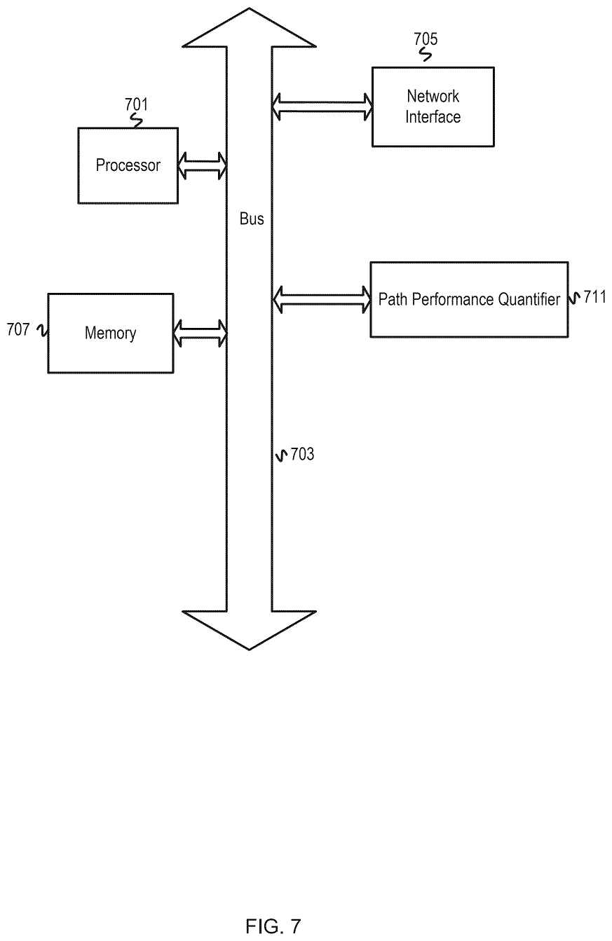

FIG. 7 depicts an example computer system with a path performance quantifier. The computer system includes a processor 701 (possibly including multiple processors, multiple cores, multiple nodes, and/or implementing multi-threading, etc.). The computer system includes memory 707. The memory 707 may be system memory or any one or more of the above already described possible realizations of machine-readable media. The computer system also includes a bus 703 and a network interface 705. The system also includes a path performance quantifier 711. The path performance quantifier 711 collects telemetry data for path metrics of an overlay network. The path performance quantifier 711 computes moving averages for collected link metrics for each link. For each path in the overlay network, the path performance quantifier 711 computes a composite performance weight for each path between the source and destination nodes. The path performance quantifier 711 ranks the paths based on their corresponding path weights, which are subsequently distributed to their corresponding overlay nodes. Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc. Further, realizations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

1. A method comprising:
collecting metrics of links of a software-defined wide area network (SD-WAN) overlay;
recurrently computing moving averages for each of the metrics for each of the links and, based on the moving averages, recurrently computing weights for paths among source and destination nodes of the SD-WAN overlay, wherein recurrently computing the weights comprises, for each path, computing a current weight based on most recently computed moving averages of the metrics of those of the links that form the path; and
based on an update criterion being satisfied, communicating to the source and destination nodes the most recently computed weights in association with the paths for path selection.

2. The method of claim 1 further comprising recurrently evaluating the update criterion, wherein the update criterion corresponds to at least one of extent of change in a weight and a change in moving average time parameter.

3. The method of claim 1, wherein computing a current weight for each path comprises identifying each set of paths between a same source node and destination node and normalizing moving averages within each set of paths.

4. The method of claim 1, wherein computing a current weight for each path comprises identifying each set of paths between a same source node and destination node and normalizing computed weights within each set of paths.

5. The method of claim 1 further comprising time-series forecasting weights of the paths with a trained machine learning model based on moving averages of the metrics of the links, wherein the trained machine learning model was trained to forecast time-series of weights for paths based on combinations of the metrics for the links.

6. The method of claim 5 further comprising associating a future timestamp for activation of the forecasted weights and communicating the forecasted weights with the future timestamp to the nodes.

7. The method of claim 1 further comprising time-series forecasting metrics for the overlay with a trained machine learning model and computing weights for paths based on the time-series forecasted metrics.

8. The method of claim 1 further comprising ranking paths by weights for each pair of source and destination nodes.

9. The method of claim 1, wherein the metrics comprise at least two of latency, jitter, link stability, bandwidth, and hops.

10. A non-transitory, machine-readable medium having stored thereon program code comprising instructions to:
collect metrics of links of a software-defined wide area network (SD-WAN) overlay;
recurrently compute moving averages for each of the metrics for each of the links and, based on the moving averages, recurrently compute weights for paths among source and destination nodes of the SD-WAN overlay, wherein the instructions to recurrently compute the weights comprise instructions to, for each path, compute a current weight based on most recently computed moving averages of the metrics of those of the links that form the path; and
based on an update criterion being satisfied, communicate to the source and destination nodes the most recently computed weights in association with the paths.

11. The non-transitory, machine-readable medium of claim 10, wherein the program code further comprises instructions to recurrently evaluate the update criterion, wherein the update criterion corresponds to at least one of extent of change in a weight and a change in time parameter for computing moving averages.

12. The non-transitory, machine-readable medium of claim 10, wherein the instructions to compute a current weight for each path comprise instructions to identify a set of paths between each pairing of source and destination nodes and to normalize moving averages within each set of paths or to normalize computed weights within each set of paths.

13. The non-transitory, machine-readable medium of claim 10, wherein the program code further comprises instructions to time-series forecast weights of the paths with a trained machine learning model based on moving averages of the metrics of the links, wherein the trained machine learning model was trained to forecast time-series of weights for paths based on combinations of the metrics for the links.

14. The non-transitory, machine-readable medium of claim 13, wherein the program code further comprises instructions to associate a future timestamp for activation of the forecasted weights and communicate the forecasted weights with the future timestamp to the nodes.

15. The non-transitory, machine-readable medium of claim 10, wherein the program code further comprises instructions to time-series forecast metrics for the overlay with a trained machine learning model and compute weights for paths based on the time-series forecasted metrics.

16. The non-transitory, machine-readable medium of claim 10, wherein the program code further comprises instructions to rank paths by weights for each pair of source and destination nodes.

17. An apparatus comprising:
a processor; and
a machine-readable medium having stored thereon instructions executable by the processor to cause the apparatus to,
collect metrics of links of a software-defined wide area network (SD-WAN) overlay;
recurrently compute moving averages for each of the metrics for each of the links and, based on the moving averages, recurrently compute weights for paths among source and destination nodes of the SD-WAN overlay, wherein the instructions to recurrently compute the weights comprise instructions to, for each path, compute a current weight based on most recently computed moving averages of the metrics of those of the links that form the path; and
based on an update criterion being satisfied, communicate to the source and destination nodes the most recently computed weights in association with the paths.

18. The apparatus of claim 17, wherein the machine-readable medium further has stored thereon instructions executable by the processor to cause the apparatus to recurrently evaluate the update criterion, wherein the update criterion corresponds to at least one of extent of change in a weight and a change in time parameter for computing moving averages.

19. The apparatus of claim 17, wherein the instructions to compute a current weight for each path comprise instructions executable by the processor to cause the apparatus to identify a set of paths between each pairing of source and destination nodes and to normalize moving averages within each set of paths or to normalize computed weights within each set of paths.

20. The apparatus of claim 17, wherein the machine-readable medium further has stored thereon instructions executable by the processor to time-series forecast weights of the paths with a trained machine learning model based on moving averages of the metrics of the links, wherein the trained machine learning model was trained to forecast time-series of weights for paths based on combinations of the metrics for the links.

21. The apparatus of claim 20, wherein the machine-readable medium further has stored thereon instructions executable by the processor to associate a future timestamp for activation of the forecasted weights and communicate the forecasted weights with the future timestamp to the nodes.

22. The apparatus of claim 17, wherein the machine-readable medium further has stored thereon instructions executable by the processor to time-series forecast metrics for the overlay with a trained machine learning model and compute weights for paths based on the time-series forecasted metrics.
